(19) United States
(12) Patent Application Publication
(10) Pub. No.: US 2013/0227929 A1
(43) Pub. Date: Sep. 5, 2013

(54) SYSTEM AND DEVICE FOR MONITORING CONTAMINANTS IN A FLUID

(71) Applicants: Abhijeet Madhukar Kulkarni, Basingstoke (GB); William Keith Albert Eyers, Chobham (GB); James Joseph Sealy, Beaconsfield (GB)

(72) Inventors: Abhijeet Madhukar Kulkarni, Basingstoke (GB); William Keith Albert Eyers, Chobham (GB); James Joseph Sealy, Beaconsfield (GB)

(73) Assignee: General Electric Company, Schenectady, NY (US)

(21) Appl. No.: 13/410,028

(22) Filed: Mar. 1, 2012

(51) Int. Cl. F02C 7/04; G06F 19/00; G01N 17/00

(52) U.S. Cl. 60/39.091; 73/31.05; 702/24

(57) ABSTRACT

This disclosure describes embodiments of a system and device for measuring corrosive components suspended in air flowing to a turbo-machine. The device comprises a fluid circuit with a detection module having a sensing element disposed in a manifold. The manifold surrounds the sensing element to prevent mixing of the flow of sample air in the manifold with air from the surrounding environment. In one example, the fluid circuit also comprises a fluid flow module with elements to monitor flow characteristics of the flow of sample air. Operation of the fluid flow module can effectuate changes in flow characteristics of the flow of sample air to optimize detection of the corrosive components.

### BACKGROUND OF THE INVENTION

The subject matter disclosed herein relates to air quality monitoring and, in particular, to embodiments of a system and a device for monitoring contaminants in sample air that enters a turbo-machine.

Gas turbines, aero-derivatives, and other varieties of turbo-machinery use an air inlet system that channels incoming air towards a compressor. The inlet system can have a filter section to screen foreign objects and other materials from the air. Typically, the inlet system and the compressor comprise metals that may corrode when in contact with certain contaminants, which come from the environment in which the turbo-machine operates.

Some turbo-machines may develop microenvironments, e.g., areas of the turbo-machine in which the air flows with different flow properties (e.g., velocity and pressure). These flow properties can increase the rate of corrosion. Moreover, the differences in the flow properties across the turbo-machine prevents the use of ambient conditions to identify the rate of corrosion that will occur throughout the various parts, areas, and microenvironments. Techniques to determine the environmental effects of the air on the turbo-machine, e.g., on the compressor components, may necessarily monitor air downstream of the turbo-machine.

One technique to measure the rate of corrosion is to place strips (hereinafter “coupons”) in the stream of air. This configuration exposes the coupons, which will over time become corroded and fail. An end user (e.g., a technician) can monitor the progress of corrosion and time to failure through, for example, periodic visual examination of coupons. For more accurate determination, however, the coupons are sent to a lab for more time consuming and expensive testing to determine the type(s) of corrosives that caused the failure.

Use of coupons can cause a few problems. The coupons may, for example, dislodge and become a projectile that can potentially cause damage to the compressor components. The coupons may also create flow distortion waves that can also damage turbo-machine components. Furthermore, access to the coupons may require shut down of the turbo-machine, which reduces the overall operating performance of the turbo-machine.

The discussion above is merely provided for general background information and is not intended to be used as an aid in determining the scope of the claimed subject matter.

### BRIEF DESCRIPTION OF THE INVENTION

This disclosure describes embodiments of a system and device to measure contaminants found in fluids, e.g., air flowing downstream of a turbo-machine. An advantage that the practice of some embodiments of the system and device is to provide real-time data about the constituent components of the fluids, including corrosive components. This data can accurately represent the rate of corrosion of components of the turbo-machine and help to identify and diagnose potential problems before damage to the turbo-machine may occur.

The disclosure describes, in one embodiment, a device to monitor corrosion in an asset. The device comprises a flow generating module generating a flow of sample air with selected flow characteristics. The device also comprises a detection module coupled to the flow generating module to receive the flow of sample air. The detection module comprises a manifold that directs the sample air in contact with a sensing element responsive to constituent components in the sample air. The device also comprises a fluid flow module that couples with the flow generating module, the fluid flow module comprising one or more elements to measure the flow characteristics of the flow of sample air.

The disclosure describes, in another embodiment, a monitoring device to measure constituent components in air. The monitoring device comprises a detection element comprising a computing device, one or more sensing elements coupled with the computing device and responsive to the constituent components, and a manifold in surrounding relation to the sensing elements to prevent exposure of the sensing elements to outside air. The monitoring device also comprises a pump in flow connection with the manifold for delivering a flow of sample air with selected flow characteristics, and a pressure meter coupled with the pump and to an air supply port. In one example, the selected flow characteristics are pre-set to effectuate detecting characteristics of the detection module.

The disclosure describes, in yet another embodiment, a system for generating power. The system comprises a turbo-machine and an inlet system coupled to the turbo-machine, the inlet system directing air from the surrounding environment to the turbo-machine. The system also includes a sampling device coupled to the inlet system and a monitoring device coupled to the sampling device. The monitoring device comprises a fluid circuit with a detection module having sensing elements to detect contaminants in sample air drawn from the inlet system by the sampling device. In one example, sample air flows through the fluid circuit with flow characteristics that are pre-set to effectuate detecting characteristics of the detection module.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts an exemplary air sampling system that couples with an inlet system to measure contaminants in air flowing to a turbo-machine;

FIG. 2 depicts a schematic diagram of an exemplary monitoring device for use in the air sampling system of FIG. 1;

FIG. 3 depicts a front view of another exemplary monitoring device for use in the air sampling system of FIG. 1;

FIG. 4 depicts a front view of the monitoring device of FIG. 3 with its access door in its closed position; and

FIG. 5 depicts perspective view of an exemplary detection module for use in the monitoring devices of FIGS. 2, 3, and 4.

### DETAILED DESCRIPTION OF THE INVENTION

Embodiments of systems and devices below can provide dynamic corrosion monitoring for turbo-machines and related systems. These embodiments deploy sensitive computing devices to collect data from sample air in real-time, thereby generating extensive information about qualities and properties of the air that is flowing into the turbo-machine. However, in one aspect, the system and devices only expose certain elements of the computing devices to the contaminants in the sample air. This features protects the sensitive equipment from damage that can interrupt operation and, often, disable the computing devices and prevent implementation of the computing devices altogether.

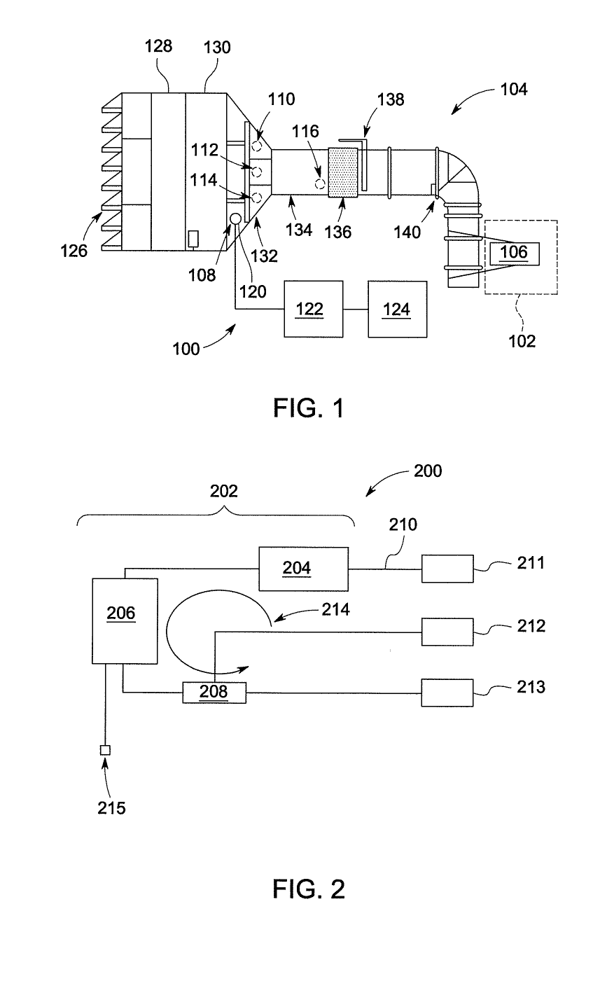

FIG. 1 depicts an exemplary air sampling system 100 (also “system 100”) that can detect, measure, and/or monitor components in a fluid (e.g., air) to prevent damage to an asset, e.g., a turbo-machine 102. For example, the sampling system 100 can detect corrosive elements in air. These corrosive elements can damage components of the turbo-machine 102. An advantage of the present design, however, is that service and/or maintenance of the system 100 can occur without disturbing operation of the turbo-machine 102. Thus, there is no need to turn off or power down the turbo-machine 102, e.g., to retrieve coupons or other devices that are in contact with or in position for exposure to air flowing to the turbo-machine 102.

The turbo-machine 102 can couple with an inlet system 104 that directs air from the surrounding environment. In one example, a compressor 106 couples with the inlet system 104 to move air through the inlet system 104 and into the turbo-machine 102. As shown in FIG. 1, the system 100 couples with the inlet system 104 at one or more sampling locations (e.g., a first sampling location 108, a second location 110, a third location 112, a fourth location 114, and a fifth location 116). The sampling locations 108, 110, 112, 114, 116 expose the system 100 to air (and/or other fluids) that flow through the interior of the inlet system 104. For example, during operation of the turbo-machine 102, the system 100 can draw off a small sample of air to determine the scope and content of contaminates that are dispersed therein.

In one embodiment, the system 100 includes a sampling device, generally denoted by the numeral 120, and a monitoring device 122. A processing device 124 couples with the monitoring device 122. The processing device 124 can comprise a computing device (e.g., a computer, laptop, mobile device) with one or more programs and/or executable instructions. Examples of the sampling device 120 can have a probe (e.g., an isokinetic probe) or nozzle in position (e.g., at sampling locations 108, 110, 112, 114, 116) to extract air at the average velocity of the air moving through the inlet system 102. This sample air has representative concentrations of dissolved, suspended, volatile, and corrosive constituents components. The monitoring device 122 can detect these constituent components and, in response, generate information (e.g., data and electrical signals) representative of some measure of the constituent components in the air. The processing device 124 receives this information via., e.g., wired and or wired connection between the sampling device 122 and the monitoring device 124. Execution of one or more of the computer programs can read and display the information to an end user (e.g., a technician).

Continuing with the discussion of the inlet system 104, and moving from left to right in the diagram of FIG. 1, in one example, the inlet system 104 includes a weather hood 126 and an inlet filter housing 128. A cooling module 130 may be found inside of the inlet filter housing 128. The cooling module 130 may include a washing system that disperses fluid (e.g., water) into the inlet filter housing 128 to facilitate filtering of the air flowing therethrough. A transition piece 132 couples the inlet filter housing 128 to an inlet duct 134. The physical characteristics of these elements help to develop certain flow characteristics (e.g., velocity, pressure, etc.) in the flow of air as the air transits the inlet system 104 to the turbo-machine 102. Inside of inlet duct 134, that air can encounter one or more other elements, e.g., a silencer section 136, heating system 138, and screen element 140. The elements 136, 138, 140 are useful for condition the air as the air travels through the inlet system 104 to the turbo-machine 102.

FIG. 2 illustrates a schematic diagram of an exemplary monitoring device 200 for use in air sampling system 100 of FIG. 1. The monitoring device 200 includes a fluid circuit 202 with a fluid flow module 204, a detection module 206, and a flow generating module 208. The fluid circuit 202 also includes tubing 210 and one or more fluid ports that permit ingress and egress of air and other fluids into and out of the monitoring device 200. In one example, the ports include a sample air port 211, an air supply port 212, and an exhaust port 213. The sample air port 211 couples with the testing location to provide sample air that flows through the flow circuit 202 in a flow pattern 214. The air supply port 212 can receive a compressed fluid (e.g., compressed air) from a separate supply and/or source. The compressed air operates the flow generating module 208. In one example, the detection module 206 couples with a data port 215, e.g., via an electrical wire, to exchange information with one or more remote devices that can couple with the data port 215 and/or directly to the electrical wire and/or directly to the detection module 206, as desired.

The data port 215 may include one or more connectors (e.g., USB connectors, RS-232 connectors) for wired connection of the monitoring device 200 to external computing resources, e.g., processing device 124 of FIG. 1. In one example, the data port 215 can also comprise one or more wireless devices (e.g., RF devices) to transmit information from the monitoring device 200 to locations remote from the monitoring device 200. Examples of the fluid ports (e.g., the sample air port 211, the air supply port 212, and the exhaust port 213) can accommodate tubes, pipes, and conduits that deliver fluids to the monitoring device 200. These fluids can comprise sample air taken upstream of a turbo-machine (e.g., turbo-machine 102). As discussed more below, the fluids can also include various supply fluids, including supply air to operate and/or facilitate operation of one or more elements of the monitoring device 200. The fluid ports can incorporate various types of couplings (e.g., quick-release fluid couplings) that can receive tubular-type elements.

Broadly, during operation of monitoring device 200, sample air enters the flow circuit 202 for testing at the detection module 206 via one or more of the fluid ports 210. The flow generating module 208 can induce certain flow characteristics (e.g., flow rate) in the sample air. The flow generating module 208 can, for example, change the pressure of the fluid to increase and decrease velocity of air in the fluid circuit 202. The flow control module 204 monitors these flow characteristics as well as other operating parameters of the sample air in the flow circuit 202.

Exemplary operating parameters can include flow characteristics (e.g., flow rate and fluid velocity) as well as temperature, pressure, contaminant levels, and similar metrics as desired. In one example, the flow characteristics are pre-set as part of a calibration and/or set-up procedure to effectuate detecting characteristics of the detection module 206. These detecting characteristics may, for example, define certain parameters of operation for the detection module 206, e.g., certain flow rate and/or velocity of air flowing across the detection module 206 that permits detection of contaminants of certain pre-determined size threshold. In another example, the flow control module 204 and the flow generating module 208 may operate in combination to manage the flow of sample air through the detection module 206. This combination may create a feedback loop to allow dynamic control of the flow of sample air to improve the results of detection, e.g., detection of contaminants in the sample air, and/or a feedback loop to modify flow characteristics of the flow of sample air to change detecting characteristics of the detection module 206.

Examples of the detection module 206 detect these contaminants. In one example, the detection module 206 includes one or more elements that react with contaminants. These reactions can register certain electrical signals and/or other signals to measure levels of corrosive contaminants (and/or other contaminant generally) found in the sample air. The electrical signals can include information (also “data”) that reflects the levels of contaminants, e.g., levels consistent with air flowing in an inlet system (e.g., inlet system 102 of FIG. 1). Details of one exemplary device for use as the detection module 206 is found in FIG. 5 and discussed more below.

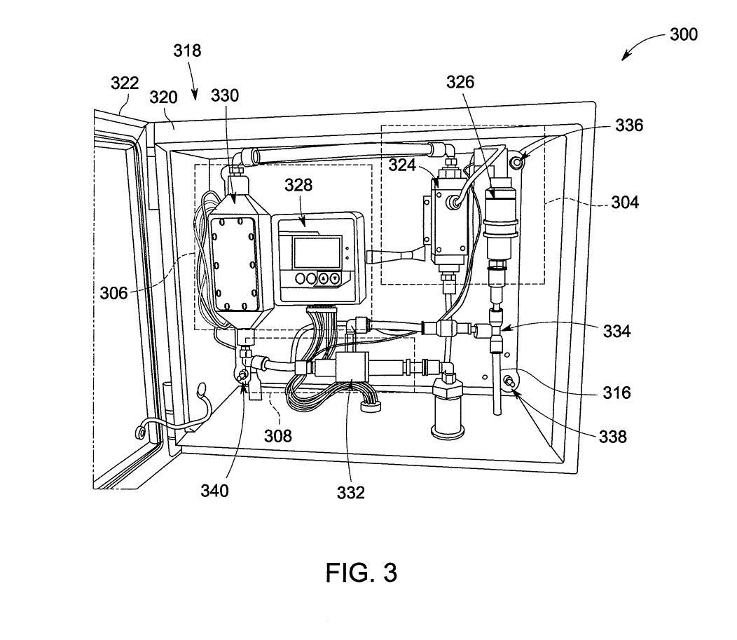

FIG. 3 depicts another exemplary monitoring device 300, which like monitoring device 200 of FIG. 2 has a flow control module 304, a detection module 306, and a flow generating module 308. Tubing 316 connects these modules together. The monitoring device 300 has an enclosure 318 with a housing 320 and an access panel 322. The elements of the enclosure 318 can work together to seal and protect the modules from the surrounding environment. Inside of the enclosure 318, the flow control module 304 includes one or more flow monitoring elements (e.g., a flow meter 324 and a pressure meter 326) to measure flow parameters of sample air flowing throughout the monitoring device 300. The detection module 306 has a computing device 328 and a manifold 330, through which the sample air enters and exits the detection module 306. The pressure meter 326 couples with a pump 332 to manage the flow of sample air through the detection module 306. In one embodiment, the monitoring device 300 includes a damping assembly 334 including one or more vibration mounts (e.g., a first mount 336, a second mount 338, and a third mount 340).

In one implementation, operation of the pump 332 draws sample air into the enclosure 318 through the manifold 330 and the flow meter 324 to form, in one example, a flow of sample air with selected flow characteristics. Examples of the pump 332 include vacuum-assisted pumps, which utilize separate supply air that flows into the enclosure 318. As shown in FIG. 3, the flow meter 324 monitors the flow rate (and/or velocity) of the flow of sample air, providing data and information to one or more external devices. In one example, the data from the flow meter 324 and the pressure meter 326 are useful to modify operation of the pump 332 to tune the flow characteristics to improve and or optimize detection of certain types of contaminants as desired.

Construction of the enclosure 318 can comprise metals, plastics, and composites of varying material properties. Suitable materials will resist severe environmental conditions to provide long lasting protection of the components found inside of the enclosure 318. Likewise, materials to construct the manifold 330 are resistant and/or inert to corrosive elements. This feature prevents breakdown of the manifold 330, which may allow the sample air to mix with air from the surrounding environment.

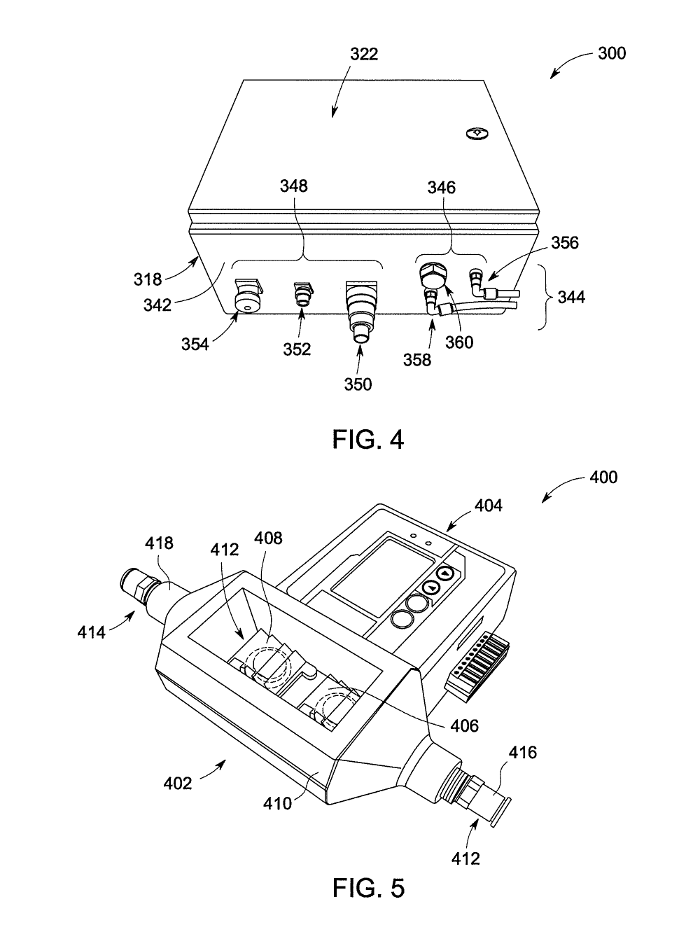

FIG. 4 depicts the monitoring device 300 of FIG. 3 with the access panel 322 in its closed position proximate the housing 320 to prevent access to the components of found therein. The housing 320 has a front wall 342 that forms an inlet/outlet (I/O) panel 344 to receive connections for various fluid and data devices. The I/O panel 344 includes fluid I/O 346 and data I/O 348, each of which can include connectors of various configurations discussed above and contemplated herein. In one example, the data I/O 348 include a flow meter I/O 350, a detection module I/O 352, and one or more extra I/O 354. The fluid I/O 346 can include an ambient air supply 356, a sample air supply 358, and a vent 360. The ambient air supply 356 can couple with an air tank or other external supply. As discussed above, air from this external supply drive the pump 332 (FIG. 3). The sample air supply 358 couples with the probe that extends into and provides sample air, e.g., from the inlet system (e.g., inlet system 104 of FIG. 1). In one example, the pump 332 couples with the vent 360 to expel the supply air during operation.

FIG. 5 depicts an example of a detection module 400 to detect constituent components of the sample of air flowing to a turbo-machine. The detection module 400 has a manifold 402 and a sensing system. A computing device 404 and one or more sensing elements (e.g., a first sensing element 406 and a second sensing element 408) embody the sensing system in the example of FIG. 5. However, the present disclosure contemplates other configurations of devices/elements that satisfy the measurement criteria and other aspects of the subject matter described herein The manifold 402 includes a manifold housing 410 that surrounds the sensing elements 406, 408 in an interior cavity 412. Although not shown, the manifold may include a cover over the interior cavity 412, which works with the manifold housing 410 to protect and segregate the sensing elements 406, 408. This configuration prevents mixing of sample air with air from the environment surrounding the manifold 402 In one example, the manifold housing 410 includes ports (e.g., a first port 412 and a second port 414) outfit with connectors (e.g., a first connector 416 and a second connector 418).

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device to monitor corrosion in an asset, said device comprising:
a flow generating module generating a flow of sample air with selected flow characteristics;
a detection module coupled to the flow generating module to receive the flow of sample air, the detection module comprising a manifold that directs the sample air in contact with a sensing element responsive to constituent components in the sample air; and
a fluid flow module that couples with the flow generating module, the fluid flow module comprising one or more elements to measure the flow characteristics of the flow of sample air.

2. The device of claim 1, further comprising an enclosure in surrounding relation to the flow generating module, the detection module, and the fluid flow module.

3. The device of claim 1, wherein the flow generating module uses supply air to modify flow characteristics of the flow of sample air.

4. The device of claim 1, wherein the sensing element is responsive to constituent components that are corrosive.

5. The device of claim 1, wherein the fluid flow module measures the velocity of the flow of sample air, and wherein the velocity is pre-set to effectuate detecting characteristics of the detection module.

6. The device of claim 1, wherein the fluid flow module monitors pressure of an external air supply.

7. The device of claim 1, wherein the flow generating module comprises a pump that draws sample air through the fluid flow module and the manifold.

8. The device of claim 1, wherein the detection module comprises a computing device coupled with the sensing element, and wherein the computing device exchanges data with an external device related to the constituent components of the sample air.

9. The device of claim 1, wherein the manifold surrounds the sensing element to prevent mixing of sample air with air from the surrounding environment.

10. A monitoring device to measure constituent components in air, said monitoring device comprising:
a detection element comprising a computing device, one or more sensing elements coupled with the computing device and responsive to the constituent components, and a manifold in surrounding relation to the sensing elements to prevent exposure of the sensing elements to outside air;
a pump in flow connection with the manifold, the pump delivering a flow of sample air with selected flow characteristics; and
a pressure meter coupled with the pump and to an air supply port,
wherein the selected flow characteristics are pre-set to effectuate detecting characteristics of the detection module.

11. The monitoring device of claim 10, further comprising a flow meter in flow connection with the pump and the pressure meter.

12. The monitoring device of claim 10, wherein the pump comprises a vacuum pump driven by supply air.

13. The monitoring device of claim 10, further comprising a housing and an access panel coupling with the housing to permit access to components stored therein, the housing comprising an inlet/outlet panel with one or more fluid ports and one or more data ports to permit fluid to flow into and out of the enclosure and the exchange of data with the computing device.

14. The monitoring device of claim 10, wherein the manifold surrounds the sensing element to prevent mixing of sample air with air from the surrounding environment.

15. A system for generating power, comprising:
a turbo-machine;
an inlet system coupled to the turbo-machine, the inlet system directing air from the surrounding environment to the turbo-machine;
a sampling device coupled to the inlet system; and
a monitoring device coupled to the sampling device, the monitoring device comprising a fluid circuit with a detection module having sensing elements to detect contaminants in sample air drawn from the inlet system by the sampling device,
wherein sample air flows through the fluid circuit with flow characteristics that are pre-set to effectuate detecting characteristics of the detection module.

16. The system of claim 15, wherein the sampling device comprises a probe that extends into the inlet system.

17. The system of claim 16, wherein the probe comprises an isokinetic probe.

18. The system of claim 15, wherein the sampling device couples to the inlet system downstream of the turbo-machine.

19. The system of claim 15, wherein the monitoring device mounts to the inlet system.
